(19) United States
(12) Patent Application Publication
(10) Pub. No.: US 2026/0186454 A1
(43) Pub. Date: Jul. 2, 2026

(54) VERIFIABLE POLICY SIMULATION SYSTEM AND METHOD THEREOF WITH INTEGRATING MULTI-CRITERIA DECISION MAKING AND SYSTEM DYNAMICS

(71) Applicant: National Sun Yat-Sen University, Kaohsiung (TW)

(72) Inventors: YU-CHUN CHEN, Kaohsiung (TW); YANG-CHI CHANG, Kaohsiung (TW); PIERRE-ALEXANDRE CHÂTEAU, Kaohsiung (TW)

(21) Appl. No.: 19/438,479

(22) Filed: Dec. 31, 2025

(30) Foreign Application Priority Data
Jan. 2, 2025 (TW) 114100171

(51) Int. Cl. G05B 13/04; G06F 18/22

(52) U.S. Cl. CPC G05B 13/04; G06F 18/22

(57) ABSTRACT

A verifiable policy simulation method includes: providing a verification model; collecting related data; simulating with the related data to build an evaluation index; providing a plurality of preliminary expert questionnaires with the evaluation index to obtain a preliminary expert result; building an ANP hierarchical structure according to the preliminary expert result; providing a plurality of ANP expert questionnaires to obtain an ANP expert result; calculating a weight of the ANP expert result to obtain a weighted value of model; calculating the ANP expert result to confirm an index of system dynamics model; producing a causal loop diagram according to the ANP expert result and the index of system dynamics model; inputting the index of system dynamics model and the causal loop diagram to the verification model to obtain a model verification data; comparing the ANP expert result with the model verification data to obtain a verification result of simulated comparison.

### BACKGROUND OF THE INVENTION

### 1. Field of the Invention

The present invention relates to a verifiable policy simulation system and method thereof with integrating multi-criteria decision making and system dynamics applied with an ANP (Analytic Network Process) method based on DEMATEL (Decision Making Trial and Evaluation Laboratory).

Particularly, the present invention relates to the verifiable policy simulation system and method thereof with integrating multi-criteria decision making and system dynamics, thereby simplifying a process flow and reducing a data amount of processing.

### 2. Description of the Related Art

For example, Taiwanese Patent Publication No. TW-1769798, entitled “Processing Strategy Analysis System for Vertical Cutting Center Machine,” discloses a processing strategy analysis system for vertical cutting center machine, including a data-capturing module, a memory module, an information module and a calculation module, with the data-capturing module, the memory module and the calculation module coupled to the information module.

As mentioned above, the calculation module has a first algorithm program, a second algorithm program and a third algorithm program, with the first algorithm program provided with Fuzzy Delphi Method, the second algorithm program provided with DEMATEL (Decision Making Trial and Evaluation Laboratory), the third algorithm program provided with DANP (DEMATEL based-on Analytic Network Process) method.

Further, another Taiwanese Utility-Model Patent Publication No. TW-M605334, entitled “Decision Making System for Developing Medical Wearable Devices,” discloses a decision making system including a data calculation device, with the data calculation device having an input module, a database and a processing module.

As mentioned above, the processing module has a key-factor calculation program for processing an influence-relevance matrix to form a super matrix, with the key-factor calculation program summing each vector of the super matrix to obtain a key-factor rank for each index weight. Furthermore, the key-factor calculation program utilizes DANP method to remove each criterion of total influence values from the influence-relevance matrix so as to transform into a normalized influence-relevance matrix from which the super matrix is calculated.

Further, another Chinese Patent Application Publication No. CN-113610444, entitled “Agricultural Modernization Development Level Evaluation Method Based on Index CorrelationDegrees,” discloses an agricultural modernization development level evaluation method based on index correlation degrees, including the step 1: selecting agricultural modernization development level evaluation indexes according to the agricultural modernization development target and current situation, and building an agricultural modernization development level evaluation index system.

As mentioned above, the agricultural modernization development level evaluation method includes the step 2: on the basis of the index correlation degree between the evaluation indexes, adopting gray correlation analysis to calculate the gray correlation degree between the indexes, constructing a direct influence matrix, and introducing a fuzzy DANP method to construct a fuzzy GRA-DANP method to determine the weight of each evaluation index.

As mentioned above, the agricultural modernization development level evaluation method includes the step 3: comprehensively evaluating the agricultural modernization development level by using a TOPSIS method. According to the agricultural modernization development level evaluation method, an agricultural modernization development level evaluation index system is established, the mutual influence relationship among the evaluation indexes is considered, the fuzzy GRA-DANP method is constructed to calculate the weight, the reliability of the weight of each index is ensured, a TOPSIS model is used for evaluating the agricultural modernization development level, and the evaluation result is more comprehensive and accurate.

Further, another Chinese Patent Application Publication No. CN-115759711, entitled “Load Management-Oriented Demand Response Execution Effect Comprehensive Evaluation Method and System,” discloses a load management-oriented demand response execution effect comprehensive evaluation method and system, with the method including the step 1: constructing a demand response execution effect evaluation index system suitable for load management.

As mentioned above, the load management-oriented demand response execution effect comprehensive evaluation method includes the step 2: for the evaluation index system, obtaining a subjective evaluation weight vector based on a DANP method; the step 3: for the evaluation index system, objective evaluation weight vectors are obtained based on an anti-entropy weight method.

As mentioned above, the load management-oriented demand response execution effect comprehensive evaluation method includes the step 4: based on the subjective evaluation weight vector and the objective evaluation weight vector, obtaining a comprehensive evaluation weight through a combined weighting method; the step 5: obtaining a final evaluation grade and score based on a grey cloud model by adopting the evaluation index and the comprehensive evaluation weight.

Further, another Chinese Patent Application Publication No. CN-115914138, entitled “Data Transmission Method, Apparatus and Device, and Dual-Connectivity PRP Node,” discloses a dual-connection PRP node, comprising a judgment logic sub-module, a two-in-one sub-module and a DANP sub-module.

As mentioned above, the judgment logic sub-module is provided with a transmitting unit and a receiving unit, with the transmitting unit respectively connected with the receiving unit and the two-in-one sub-module. The transmitting data is determined and transmitted according to a destination IP address via a communication link formed from the receiving unit or the two-in-one sub-module.

As mentioned above, the receiving unit is respectively connected with the transmitting unit and the DANP sub-module. The transmitting data is determined and received according to a source IP address via a communication link formed from the transmitting unit or the two-in-one sub-module.

As mentioned above, the two-in-one sub-module is connected with the DANP sub-module. The transmitting data is incorporated into a data link, or the DANP sub-module copies the received data to separate into two data links to transmit to an optical net and a power grid, or with incorporating the data of the optical net and the power grid to obtain a received data.

However, the DANP method described in TW-1769798, TW-M605334, CN-113610444, CN-115759711 and CN-115914138 can only be suitable for decision making purpose. Disadvantageously, the mentioned DANP method does not provide any modification suitable for enhancing a function of analytic verification, evaluation or the like.

Further, another Chinese Patent Application Publication No. CN-115456347, entitled “Verification and Evaluation Method of Tool Set Supporting Intelligent Decision,” discloses a verification and evaluation method for a tool set supporting intelligent decision making, with the verification and evaluation method including the step S1: dividing a tool set supporting intelligent decision making into different internal composition algorithms and function modules.

As mentioned above, the verification and evaluation method includes the step S2: verifying the reliability of internal composition algorithms and functional modules of different tool sets to obtain a plurality of verification results; the step S3: evaluating the verification result of the tool set by adopting a fuzzy evaluation algorithm.

However, the verification and evaluation method of tool set described in CN-115456347 can only be suitable for a tool set supporting intelligent decision making for designs, production, operation and maintenance of manufacturers or enterprises. Disadvantageously, the mentioned verification and evaluation method of tool set does not provide any modification suitable for enhancing a function of analytic verification, evaluation or the like.

Further, another Chinese Patent Application Publication No. CN-115511596, entitled “Decision-Assisting Credit Investigation Verification Evaluation Management Method and System,” discloses a decision-aided credit investigation verification evaluation management method, including the steps: obtaining user asset information, with constructing a user-defined decision model and a user asset information input model, and obtaining a user credit investigation evaluation result.

As mentioned above, the decision-aided credit investigation verification evaluation management method includes the steps: synthesizing a credit investigation management key, and obtaining user credit investigation ciphertext information; building a credit model management platform, and generating a rule file; the business personnel obtains a credit investigation verification request after verification is passed; and calling, analyzing and deploying the rule file on the credit model management platform through the loading rule, and carrying out credit management.

However, there is a need of improving the conventional DANP method for providing a verifiable policy simulation system and method with integrating multi-criteria decision making and system dynamics. The above-mentioned patents and patent application publications are incorporated herein by reference for purposes including, but not limited to, indicating the background of the present invention and illustrating the situation of the art.

### SUMMARY OF THE INVENTION

The primary objective of this invention is to provide a verifiable policy simulation system and method thereof with integrating multi-criteria decision making and system dynamics, with providing at least one verification model and collecting related documents or data, with simulating with the related data to build at least one evaluation index, with providing a plurality of preliminary expert questionnaires with the evaluation index to obtain at least one preliminary expert result, with building an ANP hierarchical structure according to the preliminary expert result, with providing a plurality of ANP expert questionnaires to obtain at least one ANP expert result, with calculating at least one weight of the ANP expert result to obtain at least one weighted value of model, with calculating the ANP expert result to confirm at least one index of system dynamics model, with producing a causal loop diagram according to the ANP expert result and the index of system dynamics model, with inputting the index of system dynamics model and the causal loop diagram to the verification model to obtain a model verification data, with comparing the ANP expert result with the model verification data to obtain a verification result of simulated comparison. Advantageously, the verifiable policy simulation system and method of the present invention is successful in simplifying processes flow, reducing a data amount of processing and providing verification analysis.

The verifiable policy simulation system in accordance with an aspect of the present invention includes:
at least one verification model provided to verify policy simulation;
at least one data collecting provided to collect related documents or data;
at least one simulation evaluation index unit provided to simulate the related documents or data to build an evaluation index;
at least one preliminary expert questionnaire unit provided to provide a plurality of preliminary expert questionnaires with the evaluation index to thereby obtain at least one preliminary expert result;
at least one ANP hierarchical structure being built according to the preliminary expert result;
at least one ANP expert questionnaire unit provided to provide a plurality of ANP expert questionnaires to obtain a ANP expert result, with calculating at least one weight of the ANP expert result to obtain at least one weighted value of model; and
a calculation unit provided with at least one causal loop diagram, with calculating the ANP expert result to confirm at least one index of system dynamics model, with producing a causal loop diagram according the ANP expert result and the index of system dynamics model;
wherein the index of system dynamics model and the causal loop diagram are input to the verification model to obtain a model verification data and the ANP expert result is compared with the model verification data to obtain a verification result of simulated comparison.

In a separate aspect of the present invention, decision orders of the ANP expert result and the weighted value of model are ranked by an OPA (Ordinal Priority Approach) method which is selected from TOPSIS.

In a further separate aspect of the present invention, the at least one verification model has a model testing procedure which is proceed to test a system dynamics model.

In yet a further separate aspect of the present invention, the model testing procedure is selected from a unit consistency testing procedure, a behavioral recreation testing procedure or combination thereof.

In yet a further separate aspect of the present invention, the calculation unit has a comparison unit which is provided to compare the ANP expert result and the model verification data.

In yet a further separate aspect of the present invention, a plurality of influent relation criteria are provided and defined by the plurality of influent relation criteria.

In yet a further separate aspect of the present invention, a plurality of mutually influent relation values are provided and obtained from the plurality of influent relation criteria.

In yet a further separate aspect of the present invention, the calculation unit has at least one direct-influence matrix which is built by the plurality of mutually influent relation values.

In yet a further separate aspect of the present invention, the calculation unit has at least one normalization model which is provided to build at least one normalized influence matrix, with calculating the at least one normalized influence matrix to obtain at least one total influence matrix which is further normalized to build at least one normalized total influence matrix, with calculating limits of the at least one normalized total influence matrix to obtain at least one limited super matrix to thereby obtain a plurality of weights of criteria.

The verifiable policy simulation method in accordance with another aspect of the present invention includes:
providing at least one verification model for verifying policy simulation;
collecting related documents or data;
simulating with the related data to build at least one evaluation index;
providing a plurality of preliminary expert questionnaires with the evaluation index to obtain at least one preliminary expert result (i.e., preliminary expert questionnaire result);
building an ANP hierarchical structure according to the preliminary expert result;
providing a plurality of ANP expert questionnaires to obtain at least one ANP expert result (i.e., ANP expert questionnaire result);
calculating at least one weight of the ANP expert result to obtain at least one weighted value of model;
calculating the ANP expert result to confirm at least one index of system dynamics model;
producing a causal loop diagram according to the ANP expert result and the index of system dynamics model;
inputting the index of system dynamics model and the causal loop diagram to the verification model to obtain a model verification data; and
comparing the ANP expert result with the model verification data to obtain a verification result of simulated comparison.

In a separate aspect of the present invention, decision orders of the ANP expert result and the weighted value of model are ranked by an OPA method which is selected from TOPSIS.

In a further separate aspect of the present invention, the at least one verification model has a model testing procedure which is proceed to test a system dynamics model.

In yet a further separate aspect of the present invention, the model testing procedure is selected from a unit consistency testing procedure, a behavioral recreation testing procedure or combination thereof.

In yet a further separate aspect of the present invention, the ANP expert result and the model verification data are compared in a comparison unit.

In yet a further separate aspect of the present invention, the plurality of ANP expert questionnaires is provided to define a plurality of influent relation criteria to obtain a plurality of mutually influent relation values.

In yet a further separate aspect of the present invention, the plurality of mutually influent relation values is provided to build at least one direct-influence matrix which is further normalized to build at least one normalized influence matrix.

In yet a further separate aspect of the present invention, the at least one normalized influence matrix is calculated to obtain at least one total influence matrix which is further normalized to build at least one normalized total influence matrix.

In yet a further separate aspect of the present invention, limits of the at least one normalized total influence matrix are calculated to obtain at least one limited super matrix to thereby obtain a plurality of weights of criteria.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram of a verifiable policy simulation system with integrating multi-criteria decision making and system dynamics in accordance with a preferred embodiment of the present invention.

FIG. 1A is a systematic diagram of a verifiable policy simulation system and method with integrating multi-criteria decision making and system dynamics applied to a marine debris or waste reduction frame in accordance with the preferred embodiment of the present invention.

FIG. 2 is a flowchart of a verifiable policy simulation method with integrating multi-criteria decision making and system dynamics in accordance with a first preferred embodiment of the present invention.

FIG. 2A is a systematic diagram of a verifiable policy simulation system and method with integrating multi-criteria decision making and system dynamics obtaining a modified version of marine debris or waste reduction in accordance with the preferred embodiment of the present invention.

FIG. 3 is a schematic diagram of a verifiable policy simulation system and method with integrating multi-criteria decision making and system dynamics obtaining a causal loop diagram in accordance with the preferred embodiment of the present invention.

FIG. 4 is a block diagram of a verifiable policy simulation system and method with integrating multi-criteria decision making and system dynamics applied to an expert integrating calculation system with an ANP method based on DEMATEL in accordance with a preferred embodiment of the present invention.

FIG. 4A is a block diagram of a verifiable policy simulation system and method with integrating multi-criteria decision making and system-dynamics applied with processing expert questionnaire in accordance with a preferred embodiment of the present invention.

FIG. 5 is a flowchart of a verifiable policy simulation system and method with integrating multi-criteria decision making and system dynamics applied to an expert integrating calculation method with an ANP method based on DEMATEL in accordance with a second preferred embodiment of the present invention.

FIG. 6 is a flowchart of a verifiable policy simulation system and method with integrating multi-criteria decision making and system dynamics applied to an expert integrating calculation method with an ANP method based on DEMATEL in accordance with a third preferred embodiment of the present invention.

FIG. 7 is a block diagram of a verifiable policy simulation system with integrating multi-criteria decision making and system dynamics in accordance with a fourth preferred embodiment of the present invention.

### DETAILED DESCRIPTION OF THE INVENTION

It is noted that a verifiable policy simulation system, method and operational method thereof with integrating multi-criteria decision making and system dynamics in accordance with the preferred embodiment of the present invention can be applicable to various questionnaires and related applications thereof (e.g., various public opinion polls and surveys, various market polls and surveys, various industrial polls and researches, various environmental investigations and surveys, various ecological investigations and surveys, various policy polls and surveys, various cultural investigation and surveys or others, which are not limitative of the present invention.

Generally, a traditional policy simulation system and method thereof with integrating multi-criteria decision making and system dynamics utilizes a calculation procedure existing several deviations or biases due to human factors such that it cannot completely express or reflect a real mental model of respondent. However, the verifiable policy simulation system, method and operational method thereof with integrating multi-criteria decision making and system dynamics of the present invention applied with a DEMATEL-based ANP method can improve calculation procedures to solve human factor deviations or biases.

Further, the verifiable policy simulation system, method and operational method thereof with integrating multi-criteria decision making and system dynamics of the present invention can be applicable to various verification analysis and modeling tests (e.g., boundary adequacy tests, structure assessment tests, dimensional consistency tests, sensitivity analysis tests, parameter assessment tests, integration error tests, behavior reproduction tests, behavior anomaly tests, surprise behavior tests, extreme condition tests, family member tests, system improvement tests or others), which are not limitative of the present invention.

Further, the verifiable policy simulation system, method and operational method thereof with integrating multi-criteria decision making and system dynamics of the present invention can be applicable to strategy or policy simulation of marine debris reduction and various situations, strategies or policy simulations (e.g., zero plan, policy and regulations, extensions of enterprise duties, education and promotion of public participation, authority removal waste at hotspots, prevention of waste discharge to sea or others), which are not limitative of the present invention.

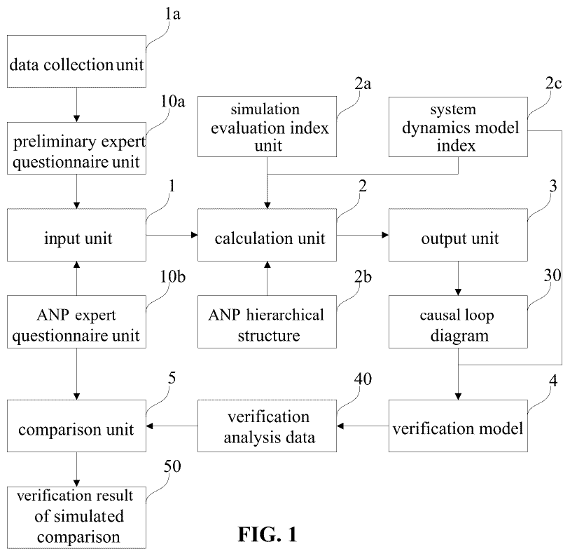

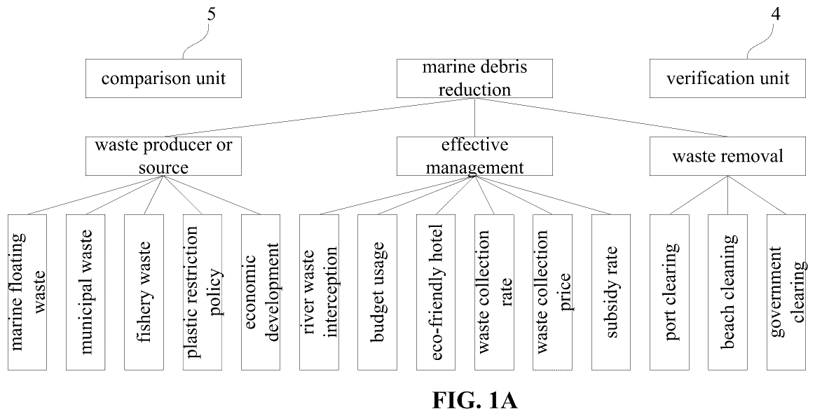

FIG. 1 shows a block diagram of a verifiable policy simulation system with integrating multi-criteria decision making and system dynamics in accordance with a preferred embodiment of the present invention. Referring now to FIG. 1, the verifiable policy simulation system with integrating multi-criteria decision making and system dynamics in accordance with a preferred embodiment of the present invention includes an input unit 1, a data collection unit 1a, a preliminary expert questionnaire unit 10a, an ANP expert questionnaire unit 10b, a calculation unit 2, a simulation evaluation index unit 2a, an ANP hierarchical structure 2b, a system dynamics model index 2c, an output unit 3 and a verification model 4.

With continued reference to FIG. 1, by way of example, the verifiable policy simulation system with integrating multi-criteria decision making and system dynamics in accordance with another preferred embodiment of the present invention includes at least one comparison unit 5 or other equivalent calculation unit having a function of comparison, as best shown at lower left side in FIG. 1.

With continued reference to FIG. 1, by way of example, the input unit 1 can be selected from a computer-data input unit or an equivalent unit having a function of inputting computer data, with the input unit 1 connecting with the data collection unit 1a in a suitable manner (e.g., cable or wireless), with the data collection unit 1a selected from a computer-data storage unit or an equivalent unit having a function of computer data storage.

With continued reference to FIG. 1, by way of example, the calculation unit 2 connects with various database units or centers in a suitable manner, with the calculation unit 2 selected from a workstation computer, a desktop computer, a notebook or laptop computer, a tablet personal computer, a mobile communication device, a smart phone or other equivalent devices having a calculation function, which are not limitative of the present invention.

With continued reference to FIG. 1, by way of example, the output unit 3 can be selected from a computer-data output unit or an equivalent unit having a function of outputting computer data, with the input unit 1, the data collection unit 1a and the output unit 3 connecting with the calculation unit 2 in a suitable manner (e.g., cable or wireless).

With continued reference to FIG. 1, by way of example, the output unit 3 connects with the calculation unit 2, with further connecting with a terminal device, a display device, a projector device, a data-storage device, a server device, a data management center or combinations thereof in a suitable manner.

With continued reference to FIG. 1, by way of example, the calculation unit 2 is provided with the simulation evaluation index unit 2a, the ANP hierarchical structure 2b and the system dynamics model index 2c which are arranged in a suitable manner.

Still referring to FIG. 1, by way of example, the verification model 4 is applied to provide a function of verification for policy simulation or a similar function of verification for policy simulation, with the verification model 4 providing a predetermined reliability or credibility, thereby processing a sequence of related policy simulation.

FIG. 1A shows a systematic diagram of a verifiable policy simulation system and method with integrating multi-criteria decision making and system dynamics applied to a marine debris or waste reduction frame in accordance with the preferred embodiment of the present invention. Turning now to FIG. 1A, the marine debris or waste reduction frame includes a first level (i.e., supreme level), a second level (i.e., intermediate level) and a third level (i.e., bottom level).

With continued reference to FIG. 1A, by way of example, the first level, the second level and the third level are arranged downward in order, with selecting the first level as a target level, with selecting the second level as a dimension level, with selecting the third level as a criteria level (e.g., index of system dynamics), with selecting three experts from academic community, authority and non-governmental organization (NGO).

Referring back to FIG. 1, the verifiable policy simulation system and method with integrating multi-criteria decision making and system dynamics can be executed with computer-executable process steps by various computer devices, e.g., workstation computers, desktop computers, notebook computers, tablet computers or other devices with calculation functions, which are not limitative of the present invention.

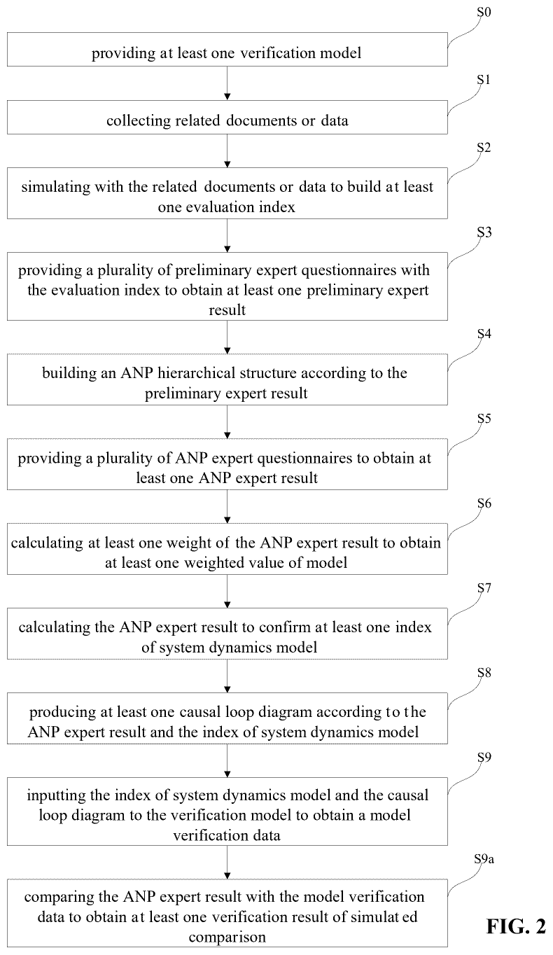

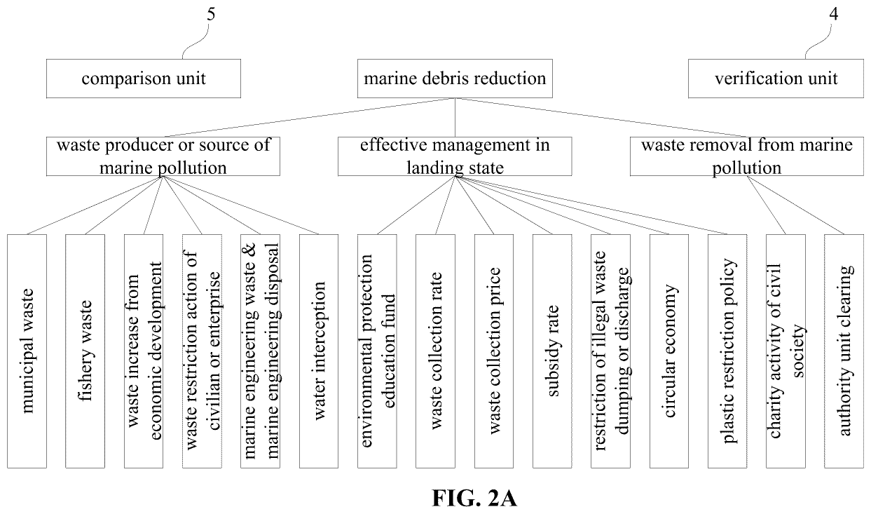

FIG. 2 shows a flowchart of a verifiable policy simulation method with integrating multi-criteria decision making and system dynamics in accordance with a first preferred embodiment of the present invention, corresponding to the verifiable policy simulation system as shown in FIG. 1. Turning now to FIGS. 1 and 2, by way of example, the verifiable policy simulation method in accordance with the first preferred embodiment of the present invention includes step S0: providing at least one or a plurality of verification models 4 in a calculation device, with operating the verification model 4 for verifying policy simulation (e.g., simulation of integrating multi-criteria decision making).

With continued reference to FIGS. 1 and 2, by way of example, the verification model 4 is applied to provide at least one verification function of policy simulation calculation, at least one analysis function of policy simulation calculation or other similar functions of calculation execution, with the verification model 4 provided in the calculation unit 2 or other equivalent units having a function of calculation.

With continued reference to FIGS. 1 and 2, by way of example, the verifiable policy simulation method in accordance with the first preferred embodiment of the present invention includes step S1: collecting the related documents or data in the data collection unit 1a or other equivalent units having a function of data collection.

With continued reference to FIGS. 1 and 2, by way of example, the verifiable policy simulation method in accordance with the first preferred embodiment of the present invention includes step S2: preliminarily simulating with the related documents or data to build at least one evaluation index in the calculation unit 2 or other equivalent units having a function of calculation.

With continued reference to FIGS. 1 and 2, by way of example, the verifiable policy simulation method in accordance with the first preferred embodiment of the present invention includes step S3: providing a plurality of preliminary expert questionnaires (e.g., expert questionnaires of Delphi method) from the preliminary expert questionnaire unit 10a with the evaluation index to obtain at least one preliminary expert result, or in an alternative embodiment, the preliminary expert result can be applied to the calculation unit 2 or other equivalent units having a function of calculation.

With continued reference to FIGS. 1 and 2, by way of example, the verifiable policy simulation method in accordance with the first preferred embodiment of the present invention includes step S4: building an ANP hierarchical structure according to the preliminary expert result, or in an alternative embodiment, the ANP hierarchical structure can be applied to the calculation unit 2 or other equivalent units having a function of calculation.

FIG. 2A shows a systematic diagram of a verifiable policy simulation system and method with integrating multi-criteria decision making and system dynamics obtaining a modified version of marine debris or waste reduction in accordance with the preferred embodiment of the present invention. Referring now to FIGS. 1, 2 and 2A, by way of example, the verifiable policy simulation method in accordance with a preferred embodiment of the present invention includes step S5: providing a plurality of ANP expert questionnaires from the ANP expert questionnaire unit 10b to obtain at least one ANP expert result, or in an alternative embodiment, the ANP expert questionnaires can be applied to the calculation unit 2 or other equivalent units having a function of calculation.

With continued reference to FIGS. 1 and 2, by way of example, the verifiable policy simulation method in accordance with the first preferred embodiment of the present invention includes step S6: in the calculation unit 2 or other units, calculating at least one weight of the ANP expert result to obtain at least one weighted value of model, as shown in Table 1, or in an alternative embodiment, the weighted value of model can be applied to the calculation unit 2 or other equivalent units having a function of calculation.

TABLE 1
a direct-influence matrix obtained from an average of ANP expert results

| X | A1 | A2 | A3 | A4 | A5 | B1 | B2 | B3 | B4 | B5 | B6 | B7 | B8 | C1 | C2 |
|---|---|---|---|---|---|---|---|---|---|---|---|---|---|---|---|
| A1 | | 0.1 | 2 | 1.6 | 0.6 | 2.6 | 1.9 | 2.2 | 1.6 | 1.6 | 1.7 | 1.9 | 2.8 | 3.2 | 2.6 |
| A2 | 0.4 | | 1.3 | 1.3 | 0.8 | 0.3 | 1.1 | 1.3 | 1 | 1.1 | 1.7 | 1 | 0.9 | 3.1 | 3.1 |
| A3 | 3.3 | 2 | | 2 | 2 | 2.3 | 1.9 | 2.4 | 1.6 | 1.7 | 2.2 | 1.9 | 2 | 3.2 | 3 |
| A4 | 3.8 | 1.8 | 2.7 | | 1.4 | 2.1 | 2 | 2.4 | 1.4 | 1.3 | 2.2 | 1.9 | 3 | 3.3 | 2.9 |
| A5 | 0.4 | 0.2 | 0.9 | 0.7 | | 0.7 | 0.4 | 0.3 | 0.4 | 0.6 | 1.7 | 0.6 | 0.6 | 1.7 | 2.7 |
| B1 | 2.9 | 0.3 | 0.9 | 0.8 | 0.4 | | 0.9 | 0.8 | 0.3 | 0.6 | 1.8 | 0.8 | 0.8 | 2.2 | 3.1 |
| B2 | 3 | 2.9 | 2.9 | 3.7 | 1.9 | 0.6 | | 2.4 | 0.9 | 0.7 | 2.1 | 1.7 | 2.2 | 3.8 | 2.6 |
| B3 | 3.4 | 3.3 | 2.9 | 2.1 | 1 | 1.8 | 1 | | 2.9 | 2.4 | 1.7 | 2.9 | 2 | 2.2 | 2.3 |
| B4 | 2.9 | 3.2 | 2.9 | 2.1 | 1 | 1.7 | 0.7 | 3.8 | | 2.9 | 2.6 | 3 | 2 | 1.4 | 1.4 |
| B5 | 2.9 | 3.2 | 2.3 | 1.8 | 1.2 | 1.1 | 0.7 | 3.7 | 3.2 | | 2.2 | 2.6 | 2 | 1.1 | 1.3 |
| B6 | 2.3 | 1.7 | 2.3 | 1.2 | 1.6 | 2.6 | 0.8 | 0.6 | 1 | 1.2 | | 0.7 | 0.8 | 2.1 | 2.6 |
| B7 | 2.7 | 2.8 | 3.1 | 2.4 | 1.2 | 1.2 | 0.9 | 3 | 2.6 | 2.6 | 1.7 | | 1.4 | 2 | 2 |
| B8 | 3.8 | 1.4 | 3.3 | 3.8 | 0.7 | 1.4 | 2.4 | 1.8 | 1.3 | 1.7 | 1.7 | 1.2 | | 3.1 | 2.7 |
| C1 | 2.3 | 1.6 | 1.9 | 2.7 | 0.9 | 1 | 1.9 | 1.6 | 1 | 1.1 | 1.2 | 1 | 2.1 | | 2.9 |
| C2 | 2.2 | 2.2 | 1.6 | 1.7 | 1.2 | 1.2 | 0.9 | 0.9 | 0.4 | 0.9 | 1.4 | 0.6 | 1 | 2.6 | |

With continued reference to FIGS. 1 and 2, by way of example, the verifiable policy simulation method in accordance with the first preferred embodiment of the present invention includes step S7: in the calculation unit 2 or other equivalent units, calculating the ANP expert result to confirm at least one index of system dynamics model 2c, as best shown at third level (i.e., criteria level) in FIG. 2A, or in an alternative embodiment, the weighted value of model can be applied to the calculation unit 2 or other equivalent units having a function of calculation.

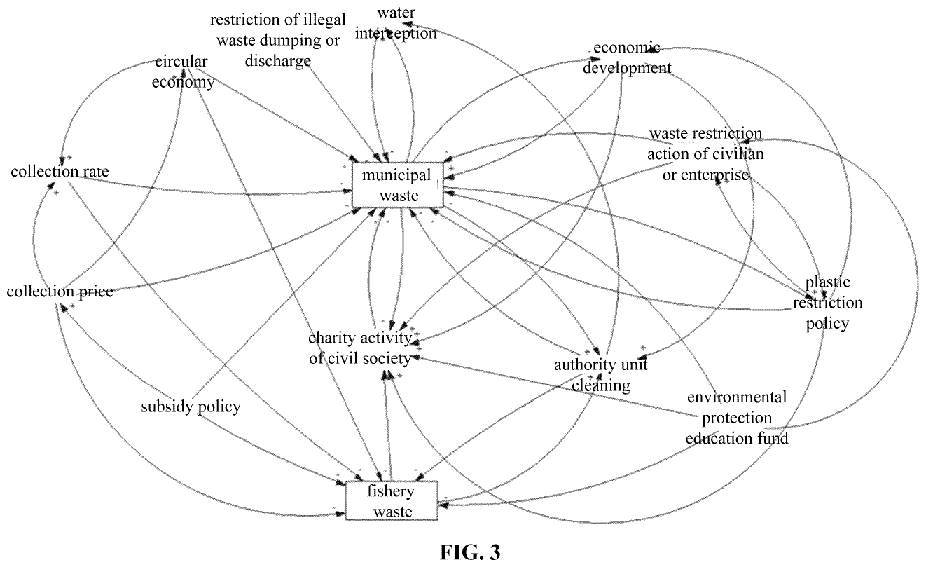

FIG. 3 shows a schematic diagram of a verifiable policy simulation system and method with integrating multi-criteria decision making and system dynamics obtaining a causal loop diagram in accordance with the preferred embodiment of the present invention. Referring now to FIGS. 1, 2 and 3, by way of example, the verifiable policy simulation method in accordance with the first preferred embodiment of the present invention includes step S8: in the calculation unit 2 or other units, producing at least one causal loop diagram 30 according to the ANP expert result and the index of system dynamics model 2c, as best shown in FIGS. 1 and 3.

With continued reference to FIGS. 1 and 2, by way of example, the verifiable policy simulation method in accordance with the first preferred embodiment of the present invention includes step S9: in the calculation unit 2 or other equivalent units, inputting the index of system dynamics model 2c and the causal loop diagram 30 to the verification model 4 to obtain a model verification data 40.

With continued reference to FIGS. 1, 2 and 3, by way of example, the verification model 4 has at least one model testing provided to test a system dynamics model. The model testing can be selected from a dimensional consistency test, a behavior reproduction test or combination thereof, with the model testing further selected from a boundary adequacy test, a structure assessment test, a sensitivity analysis test, a parameter assessment test, an integration error test, a behavior anomaly test, a surprise behavior test, an extreme condition test, a family member test, a system improvement test or other tests.

With continued reference to FIGS. 1 and 2, by way of example, the verifiable policy simulation method in accordance with the first preferred embodiment of the present invention includes step S9a: in the calculation unit 2 or other equivalent units, comparing the ANP expert result with the model verification data 40 to obtain at least one verification result 50 of simulated comparison via the comparison unit 5.

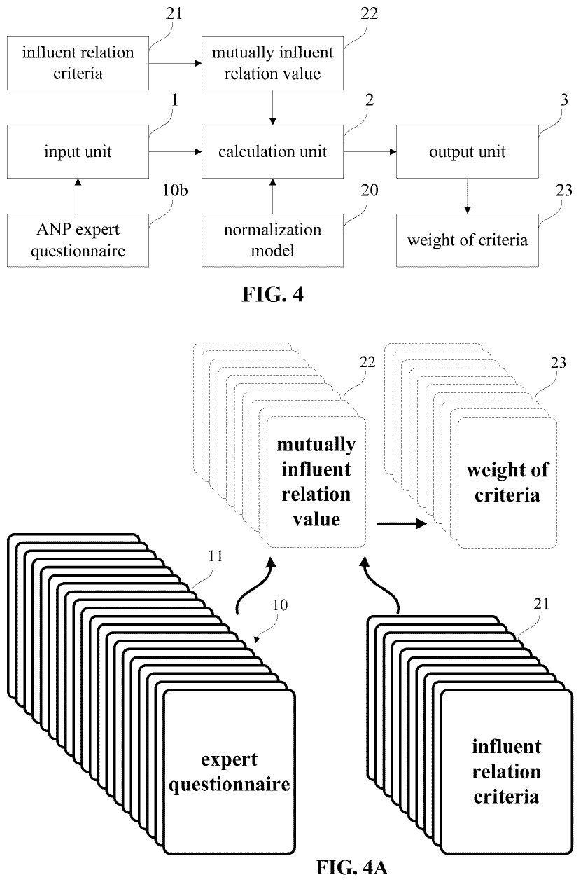

FIG. 4 shows a block diagram of a verifiable policy simulation system and method with integrating multi-criteria decision making and system dynamics applied to an expert integrating calculation system with an ANP method based on DEMATEL in accordance with a preferred embodiment of the present invention. Referring now to FIG. 4, the expert integrating calculation system with a DANP method in accordance with a preferred embodiment of the present invention includes an input unit 1, an expert questionnaire unit 10b, a calculation unit 2 and an output unit 3.

With continued reference to FIG. 4, the calculation unit 2 has at least one normalization model 20. Generally, there mainly have two normalization methods, with first method selecting a maximum of total vector sum in each row as a normalization criteria, with second method selecting a maximum of total vector sum in each row and column as a normalization criteria.

FIG. 4A shows a block diagram of a verifiable policy simulation system and method with integrating multi-criteria decision making and system dynamics applied with processing expert questionnaire in accordance with a preferred embodiment of the present invention, corresponding to the expert questionnaire system in FIG. 4.

Referring now to FIGS. 4 and 4A, expert questionnaire units 10 in accordance with a preferred embodiment of the present invention include a plurality of expert questionnaires 11 produced by several experts (e.g., filling operation). Generally, there provide various criteria in the system, with executing the questionnaires 11 for comparison according to criteria.

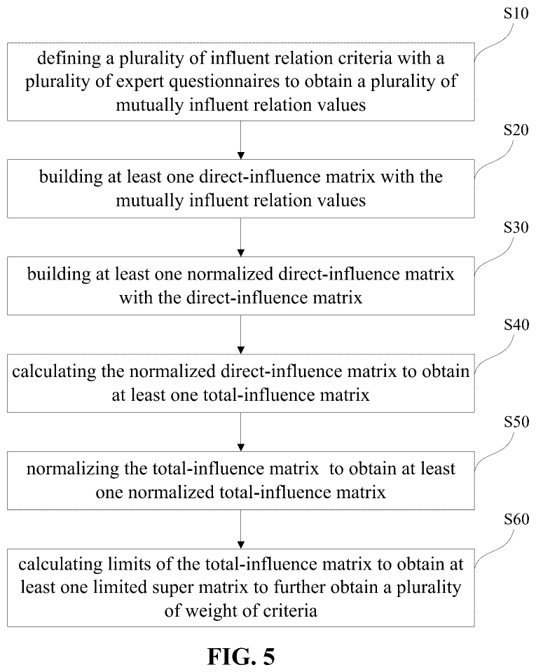

FIG. 5 shows a flowchart of a verifiable policy simulation system and method with integrating multi-criteria decision making and system-dynamics applied to an expert integrating calculation method with an ANP method based on DEMATEL in accordance with a second preferred embodiment of the present invention. Referring now to FIGS. 4, 4A and 5, the expert integrating calculation method in accordance with the second preferred embodiment of the present invention includes step S10: defining a plurality of influent relation criteria 21 with the expert questionnaires 11 to obtain a plurality of mutually influent relation values 22.

With continued reference to FIGS. 4, 4A and 5, by way of example, the influent relation criteria 21 adopts pairwise comparison of the expert questionnaires 11, with the mutually influent relation values 22 including no influence, low influence, medium influence, high influence, extremely high influence which has a predetermined scale, with the predetermined scale including influence value 0 for no influence, influence value 1 for low influence, influence value 2 for medium influence, influence value 3 for high influence, influence value 4 for extremely high influence.

With continued reference to FIGS. 4, 4A and 5, by way of example, the expert integrating calculation method in accordance with the second preferred embodiment of the present invention includes step S20: building at least one direct-influence matrix X (e.g., initial-influence matrix) with the mutually influent relation values 22.

By way of example, after defining a degree of influence, the direct-influence matrix X can be built, with, if existing a number of evaluation criteria “n”, processing pairwise comparison for each of criteria according to its influence value to form n*n direct-influence matrix X=[Xᵢⱼ], where Xᵢⱼ is an influence value of criterion “i” on criterion “j”, diagonal element is an influence value of each criteria, 0 value is set no influence.

The direct-influence matrix X of the preferred embodiment of the present invention is as follows:

$$X = [ \begin{matrix}0 & {X}_{12} & ⋯ & {X}_{1 n} \\ {X}_{21} & 0 & ⋯ & {X}_{2 n} \\ ⋮ & ⋮ & ⋱ & ⋮ \\ {X}_{n 1} & {X}_{n 2} & ⋯ & 0\end{matrix} ]$$

where Xᵢⱼ is an influence value of criterion “i” on criterion “j”.

With continued reference to FIGS. 4, 4A and 5, by way of example, the expert integrating calculation method in accordance with the second preferred embodiment of the present invention includes step S30: building at least one normalized direct-influence matrix D with the direct-influence matrix X.

The normalized direct-influence matrix D of the preferred embodiment of the present invention is as follows:

$$D = k X$$

$$k = \frac{1}{max [ {max}_{1 \leq i \leq n} {\sum }_{j = 1}^{n} {X}_{ij} , {max}_{1 \leq j \leq n} {\sum }_{i = 1}^{n} {X}_{ij} ]}$$

where D is normalized direct-influence matrix and k is a reference value of normalization.

With continued reference to FIGS. 4, 4A and 5, by way of example, the expert integrating calculation method in accordance with the second preferred embodiment of the present invention includes step S40: calculating the normalized direct-influence matrix D to obtain at least one total-influence matrix T (i.e., total-influence relation matrix).

With continued reference to FIGS. 4, 4A and 5, by way of example, the total-influence matrix T (i.e., total-influence relation matrix) in the second preferred embodiment is formed from combining the direct-influence matrix X (i.e., direct-influence relation matrix) suitably with an indirect-influence matrix ID (i.e., indirect-influence relation matrix).

In the second preferred embodiment, after obtaining the normalized direct-influence matrix D (i.e., normalized direct-influence relation matrix), the total-influence matrix T (i.e., total-influence relation matrix) can be considered as the direct-influence matrix X (i.e., direct-influence relation matrix) adding to the indirect-influence matrix ID (i.e., indirect-influence relation matrix).

In the preferred embodiment, absorbing Markov Chain can be used to delete rows or columns which can cause an absorbing state to obtain a sub-stochastic matrix as follows:

$$\begin{matrix}{lim}_{s \to ∞} {D}^{z} = 0 & {lim}_{s \to ∞}\end{matrix} ( I + D + {D}^{2} + … + {D}^{8} ) = {( I - D )}^{- 1}$$

where 0 is zero matrix and I is identity matrix.

In the preferred embodiment, the total-influence matrix T is as follows:

$$T = {lim}_{s \to ∞} ( D + {D}^{2} + {D}^{3} + … + {D}^{8} ) = {D ( I - D )}^{- 1}$$

With continued reference to FIGS. 4, 4A and 5, by way of example, the expert integrating calculation method in accordance with the second preferred embodiment of the present invention includes step S50: normalizing the total-influence matrix T to obtain at least one normalized total-influence matrix T_{C}.

In the preferred embodiment, the normalized total-influence matrix T_{C} is calculated with an equation as follows:

$${T}_{c} = [ \begin{matrix}{t}_{11} & {t}_{12} & ⋯ & {t}_{1 n} \\ {t}_{21} & {t}_{22} & ⋯ & {t}_{2 n} \\ ⋮ & ⋮ & ⋱ & ⋮ \\ {t}_{n 1} & {t}_{n 2} & ⋯ & {t}_{nn}\end{matrix} ]$$

where tᵢⱼ is an influence value of criterion “i” on criterion “j” and n is a total number of criteria.

In the preferred embodiment, the reference normalization of the total-influence matrix T is calculated with an equation as follows:

$${f}_{i} = {\sum }_{i = 1}^{n} {t}_{ij}$$

where fᵢ is a reference normalization.

In the preferred embodiment, an influence value of criteria is adopted to normalize the total-influence matrix T and the normalized total-influence matrix T_{C}* is calculated with an equation as follows:

$${T}_{C}^{*} = [ \begin{matrix}{t}_{11} / {f}_{1} & {t}_{12} / {f}_{2} & ⋯ & {t}_{1 n} / {f}_{n} \\ {t}_{21} / {f}_{1} & {t}_{22} / {f}_{2} & ⋯ & {t}_{2 n} / {f}_{n} \\ ⋮ & ⋮ & ⋱ & ⋮ \\ {t}_{n 1} / {f}_{1} & {t}_{n 2} / {f}_{2} & ⋯ & {t}_{nn} / {f}_{n}\end{matrix} ] = [ \begin{matrix}{t}_{11}^{*} & {t}_{12}^{*} & ⋯ & {t}_{1 n}^{*} \\ {t}_{21}^{*} & {t}_{22}^{*} & ⋯ & {t}_{2 n}^{*} \\ ⋮ & ⋮ & ⋱ & ⋮ \\ {t}_{n 1}^{*} & {t}_{n 2}^{*} & ⋯ & {t}_{nn}^{*}\end{matrix} ]$$

With continued reference to FIGS. 4, 4A and 5, by way of example, Delphi method is applied to confirm each of criteria and its definition and a dimension influence is ignored when a plurality of the influence relations of criteria is defined by a plurality of the expert questionnaires. Furthermore, a unified normalization operation is adopted when normalizing the total-influence matrix.

With continued reference to FIGS. 4, 4A and 5, by way of example, the expert integrating calculation method in accordance with the second preferred embodiment of the present invention includes step S60: calculating limits of the normalized total-influence matrix T_{C} to obtain at least one limited super matrix L to further obtain a plurality of weights of criteria 23.

In the preferred embodiment, no calculation of weight criteria for super matrix is necessary because an influence of criteria can be used to calculate dimension influence. A value of each matrix row approaches stable in limit calculation since a total of vectors for each row of weighted super matrix is 1, thereby applying such a characteristic to calculate each weight value of criteria.

In the preferred embodiment, a weighted super matrix is continuously multiplied by itself for the limited super matrix L to obtain a stable state.

In the preferred embodiment, the limited super matrix L is calculated with an equation as follows:

$$L = {S}^{m} = [ \begin{matrix}{I}_{11} & {I}_{12} & ⋯ & {I}_{1 n} \\ {I}_{21} & {I}_{22} & ⋯ & {I}_{2 n} \\ ⋮ & ⋮ & ⋱ & ⋮ \\ {I}_{n 1} & {I}_{n 2} & ⋯ & {I}_{nn}\end{matrix} ]$$

In the preferred embodiment, the weighted super matrix is continuously multiplied by itself for the weighted super matrix to obtain a stable state where m is a number of self-multiplying for stable states, and each weight value of dimensions can be obtained by adding each weight value of criteria of dimensions.

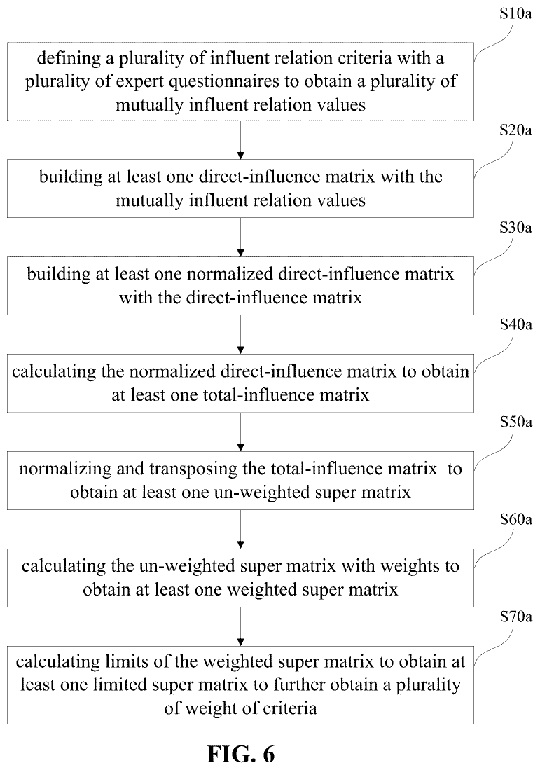

FIG. 6 shows a flowchart of a verifiable policy simulation system and method with integrating multi-criteria decision making and system dynamics applied to an expert integrating calculation method with an ANP method based on DEMATEL in accordance with a third preferred embodiment of the present invention, corresponding to the ANP method based on DEMATEL in FIG. 5. Referring now to FIG. 6, in comparison with the second embodiment, the expert integrating calculation method of the third preferred embodiment has a complicated processing flow and an increase amount of data processing.

With continued reference to FIGS. 4, 4A and 6, by way of example, the expert integrating calculation method in accordance with the third preferred embodiment of the present invention includes step S10a: defining a plurality of influent relation criteria 21 with the expert questionnaires 11 to obtain a plurality of mutually influent relation values 22 (as S10 shown in FIG. 5).

With continued reference to FIGS. 4, 4A and 6, by way of example, the expert integrating calculation method in accordance with the third preferred embodiment of the present invention includes step S20a: building at least one direct-influence matrix X (e.g., initial-influence matrix) with the mutually influent relation values 22 (as S20 shown in FIG. 5).

With continued reference to FIGS. 4, 4A and 6, by way of example, the expert integrating calculation method in accordance with the third preferred embodiment of the present invention includes step S30a: building at least one normalized direct-influence matrix D with the direct-influence matrix X.

With continued reference to FIGS. 4, 4A and 6, by way of example, the expert integrating calculation method in accordance with the third preferred embodiment of the present invention includes step S40a: calculating the normalized direct-influence matrix D to obtain at least one total-influence matrix T (as S40 shown in FIG. 5).

With continued reference to FIGS. 4, 4A and 6, by way of example, the expert integrating calculation method in accordance with the third preferred embodiment of the present invention includes step S50a: normalizing and transposing the total-influence matrix T to obtain at least one un-weighted total-influence matrix T_{C} (un-weighted super matrix W).

In the preferred embodiment, the un-weighted total-influence matrix T_{C} is calculated with an equation as follows:

$${T}_{c} = [ \begin{matrix}{t}_{11} & {t}_{12} & … & {t}_{1 n} \\ {t}_{21} & {t}_{22} & … & {t}_{2 n} \\ ⋮ & ⋮ & ⋱ & ⋮ \\ {t}_{n 1} & {t}_{n 2} & … & {t}_{nn}\end{matrix} ]$$

where tᵢⱼ is an influence value of criterion “i” on criterion “j” and n is a total number of criteria.

In the preferred embodiment, the reference normalization fᵢ of the total-influence matrix T is calculated with an equation as follows:

$${f}_{i} = {\sum }_{j = 1}^{n} {t}_{ij}$$

where values of fᵢ are calculated in different dimensions, e.g., criteria 1 to 5 pertaining to first dimension and criteria 6 to 13 pertaining to second dimension; normalization reference values of 1-5 front columns in first dimension are calculated by a sum of row vectors in 1-5 front columns of matrix T_{c} to obtain the number n of fᵢ values; normalization reference values of 6-13 columns in second dimension are calculated by a sum of row vectors in 6-13 columns of matrix T_{c} to obtain the number n of fᵢ values.

In the preferred embodiment, the total-influence matrix T is normalized with an equation as follows:

$${T}_{C}^{*} = [ \begin{matrix}{t}_{11} / {f}_{1} & {t}_{12} / {f}_{1} & … & {t}_{1 n} / {f}_{1} \\ {t}_{21} / {f}_{2} & {t}_{22} / {f}_{2} & … & {t}_{2 n} / {f}_{2} \\ ⋮ & ⋮ & ⋱ & ⋮ \\ {t}_{n 1} / {f}_{n} & {t}_{n 2} / {f}_{n} & … & {t}_{n n} / {f}_{n}\end{matrix} ] = [ \begin{matrix}{t}_{11}^{*} & {t}_{12}^{*} & … & {t}_{1 n}^{*} \\ {t}_{21}^{*} & {t}_{22}^{*} & … & {t}_{2 n}^{*} \\ ⋮ & ⋮ & ⋱ & ⋮ \\ {t}_{n 1}^{*} & {t}_{n 2}^{*} & … & {t}_{nn}^{*}\end{matrix} ]$$

where normalization is calculated by dimensions with an assumption of previous step, 1-5 front columns in first dimension of normalized total-influence matrix are normalized with individually dividing values of 1-5 front columns by each normalization reference of rows five times per each column; 6-13 columns in second dimension of normalized total-influence matrix are normalized with individually dividing values of 6-13 columns by each normalization reference of rows five times per each column.

In the preferred embodiment, the total-influence matrix T is normalized and transposed to obtain un-weighted super matrix W with an equation as follows:

$$W = {( {T}_{C}^{*} )}^{′} = [ \begin{matrix}{t}_{11}^{*} & {t}_{12}^{*} & … & {t}_{n 1}^{*} \\ {t}_{21}^{*} & {t}_{22}^{*} & … & {t}_{n 2}^{*} \\ ⋮ & ⋮ & ⋱ & ⋮ \\ {t}_{1 n}^{*} & {t}_{2 n}^{*} & … & {t}_{nn}^{*}\end{matrix} ] = [ \begin{matrix}{w}_{11} & {w}_{12} & … & {w}_{1 n} \\ {w}_{21} & {w}_{22} & … & {w}_{2 n} \\ ⋮ & ⋮ & ⋱ & ⋮ \\ {w}_{n 1} & {w}_{n 2} & … & {w}_{nn}\end{matrix} ]$$

With continued reference to FIGS. 4, 4A and 6, by way of example, the expert integrating calculation method in accordance with the third preferred embodiment of the present invention includes step S60a: calculating weights of the un-weighted super matrix W to obtain at least one weighted super matrix which is weight-calculated with dimensions of total-influence matrix obtained from DEMATEL.

In the preferred embodiment, the un-weighted super matrix W is normalized by dimensions of total-influence matrix T_{D} with an equation as follows:

$${T}_{D} = [ \begin{matrix}{t}_{D}^{11} & {t}_{D}^{12} & … & {t}_{D}^{1 n} \\ {t}_{D}^{21} & {t}_{D}^{22} & … & {t}_{D}^{2 n} \\ ⋮ & ⋮ & ⋱ & ⋮ \\ {t}_{D}^{n 1} & {t}_{D}^{n 2} & … & {t}_{D}^{nn}\end{matrix} ]$$

where tᵢⱼ is a total influence value of dimension “i” on dimension “j” and n is a total number of dimensions.

In the preferred embodiment, normalization references vᵢ and dimensions of total-influence matrix T_{D} are as follows:

$${v}_{i} = {\sum }_{j = 1}^{n} {t}_{D}^{ij}$$

$${T}_{D}^{*} = [ \begin{matrix}{t}_{D}^{11} / {v}_{1} & {t}_{D}^{12} / {v}_{1} & … & {t}_{D}^{1 n} / {v}_{1} \\ {t}_{D}^{21} / {v}_{2} & {t}_{D}^{22} / {v}_{v} & … & {t}_{D}^{2 n} / {v}_{2} \\ ⋮ & ⋮ & ⋱ & ⋮ \\ {t}_{D}^{n 1} / {v}_{n} & {t}_{D}^{n 2} / {v}_{n} & … & {t}_{D}^{nn} / {v}_{n}\end{matrix} ]$$

In the preferred embodiment, the weighted super matrix S is calculated by multiplying un-weighted super matrix W with weights as follows:

$$S = {W ( {T}_{D}^{*} )}^{′} = [ \begin{matrix}{s}_{11} & {s}_{12} & … & {s}_{1 n} \\ {s}_{21} & {s}_{22} & … & {s}_{2 n} \\ ⋮ & ⋮ & ⋱ & ⋮ \\ {s}_{n 1} & {s}_{n 2} & … & {s}_{nn}\end{matrix} ]$$

In the preferred embodiment, dimensions of total-influence matrix must be transposed after normalization and further weight-calculated according to its associated positions so as to satisfy each sum of column vectors of weighted super matrix to 1 otherwise causing failure in calculation. Further, associated positions of criteria in dimensions should be noticed to avoid calculation errors.

With continued reference to FIGS. 4, 4A and 6, by way of example, the expert integrating calculation method in accordance with the third preferred embodiment of the present invention includes step S70a: calculating limits of the weighted super matrix to obtain at least one limited super matrix L to further obtain a plurality of weights of criteria 23 (as S60 shown in FIG. 5).

In the preferred embodiment, dimensions of weighted super matrix S has each sum of column vectors of weighted super matrix to 1 so that limit calculation for each row of matrix approaches stable and is suitable for calculation of weight values. The limited super matrix L is calculated as follows:

$$L = {S}^{m} = [ \begin{matrix}{l}_{11} & {l}_{12} & … & {l}_{1 n} \\ {l}_{21} & {l}_{22} & … & {l}_{2 n} \\ ⋮ & ⋮ & ⋱ & ⋮ \\ {l}_{n 1} & {l}_{n 2} & … & {l}_{nn}\end{matrix} ]$$

In the preferred embodiment, the weighted super matrix is continuously multiplied by itself to obtain a stable state, where m is a number of self-multiplication to stable state.

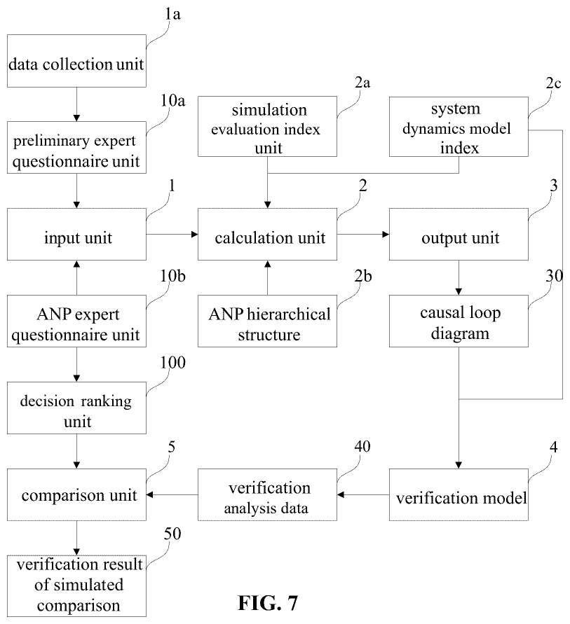

FIG. 7 shows a block diagram of a verifiable policy simulation system with integrating multi-criteria decision making and system dynamics in accordance with a fourth preferred embodiment of the present invention. Referring now to FIG. 7, in comparison with the first embodiment, the verifiable policy simulation system in accordance with a fourth preferred embodiment of the present invention further has a decision ranking unit 100.

With continued reference to FIG. 7, by way of example, the decision ranking unit 100 has an OPA method selected from TOPSIS (Technique for Order Preference by Similarity to Ideal Solution) having a positive-ideal solution and a negative-ideal solution.

Suppose a known decision matrix D=n*m with weighted matrix is W (1*m (Σ^{W}^{ᵢ}=1)). The TOPSIS has step 1: calculating assessment values of normalization with an equation as follows:

$${r}_{ij} = {x}_{ij} / \sqrt{{\sum }_{i = 1}^{m} {x}_{ij}^{2}}$$

where Xᵢⱼ is an original assessment of attribute j in option i.

As mentioned above, the TOPSIS has step 2: calculating weights of normalized assessment values, with deciding associated weights of criteria of attributes for multiplication the normalized assessment values as follows:

$${v}_{ij} = {W}_{j} {r}_{ij}$$

where i is an option, j is an attribute and wⱼ is a weight of attribute j.

As mentioned above, the TOPSIS has step 3: deciding positive-ideal solution A* and a negative-ideal solution A− as follows:

$${A}^{*} = \{ V {1}^{*} , {V 2}^{*} , … , {VN}^{*} \}$$

$${A}^{-} = \{ V {1}^{-} , {V 2}^{-} , … , {VN}^{-} \}$$

As mentioned above, the TOPSIS has step 4: calculating Euclidean distance of positive-ideal solution A* and negative-ideal solution A− as follows:

$${S}_{i}^{*} = \sqrt{{\sum }_{j = 1}^{n} {( {v}_{ij} - {v}_{j}^{*} )}^{2}}$$

$${S}_{i}^{-} = \sqrt{{\sum }_{j = 1}^{n} {( {v}_{ij} - {v}_{j}^{-} )}^{2}}$$

As mentioned above, the TOPSIS has step 5: calculating relative similarity of ideal solution for each alternative option as follows:

$${C}_{i}^{*} = \frac{{S}_{i}^{-}}{( {S}_{i}^{*} + {S}_{i}^{-} )} where 0 ≦ C {i}^{*} ≦ 1 .$$

As mentioned above, the TOPSIS has step 6: according to ranks of relative similarity of ideal solution for each alternative option, calculating order preference with value

$${C}_{i}^{*} ,$$

where higher value

$${C}_{i}^{*}$$

has greater preference and vice versa.

Although the invention has been described in detail with reference to its presently preferred embodiment, it will be understood by one of ordinary skills in the art that various modifications can be made without departing from the spirit and the scope of the invention, as set forth in the appended claims.

What is claimed is:

1. A verifiable policy simulation system comprising:
at least one verification model provided to verify policy simulation;
at least one data collecting provided to collect related documents or data;
at least one simulation evaluation index unit provided to simulate the related documents or data to build an evaluation index;
at least one preliminary expert questionnaire unit provided to provide a plurality of preliminary expert questionnaires with the evaluation index to thereby obtain at least one preliminary expert result;
at least one ANP hierarchical structure being built according to the preliminary expert result;
at least one ANP expert questionnaire unit provided to provide a plurality of ANP expert questionnaires to obtain a ANP expert result, with calculating at least one weight of the ANP expert result to obtain at least one weighted value of model; and
a calculation unit provided with at least one causal loop diagram, with calculating the ANP expert result to confirm at least one index of system dynamics model, with producing a causal loop diagram according the ANP expert result and the index of system dynamics model;
wherein the index of system dynamics model and the causal loop diagram are input to the verification model to obtain a model verification data and the ANP expert result is compared with the model verification data to obtain a verification result of simulated comparison.

2. The system as defined in claim 1, wherein decision orders of the ANP expert result and the weighted value of model are ranked by an OPA method which is selected from TOPSIS.

3. The system as defined in claim 1, wherein the at least one verification model has a model testing procedure which is proceed to test a system dynamics model.

4. The system as defined in claim 1, wherein the model testing procedure is selected from a unit consistency testing procedure, a behavioral recreation testing procedure or combination thereof.

5. The system as defined in claim 1, wherein the calculation unit has a comparison unit which is provided to compare the ANP expert result and the model verification data.

6. The system as defined in claim 1, wherein a plurality of influent relation criteria are provided and defined by the plurality of ANP expert questionnaires.

7. The system as defined in claim 1, wherein a plurality of mutually influent relation values are provided and obtained from the plurality of influent relation criteria.

8. The system as defined in claim 7, wherein the calculation unit has at least one direct-influence matrix which is built by the plurality of mutually influent relation values.

9. The system as defined in claim 1, wherein the calculation unit has at least one normalization model which is provided to build at least one normalized influence matrix, with calculating the at least one normalized influence matrix to obtain at least one total influence matrix which is further normalized to build at least one normalized total influence matrix, with calculating limits of the at least one normalized total influence matrix to obtain at least one limited super matrix to thereby obtain a plurality of weights of criteria.

10. A verifiable policy simulation method comprising:
providing a verification model for verifying policy simulation;
collecting related documents or data;
simulating with the related data to build at least one evaluation index;
providing a plurality of preliminary expert questionnaires with the evaluation index to obtain at least one preliminary expert result;
building an ANP hierarchical structure according to the preliminary expert result;
providing a plurality of ANP expert questionnaires to obtain at least one ANP expert result;
calculating at least one weight of the ANP expert result to obtain at least one weighted value of model;
calculating the ANP expert result to confirm at least one index of system dynamics model;
producing a causal loop diagram according to the ANP expert result and the index of system dynamics model;
inputting the index of system dynamics model and the causal loop diagram to the verification model to obtain a model verification data; and
comparing the ANP expert result with the model verification data to obtain a verification result of simulated comparison.

11. The method as defined in claim 10, wherein decision orders of the ANP expert result and the weighted value of model are ranked by an OPA method which is selected from TOPSIS.

12. The method as defined in claim 10, wherein the at least one verification model has a model testing procedure which is proceed to test a system dynamics model.

13. The method as defined in claim 10, wherein the model testing procedure is selected from a unit consistency testing procedure, a behavioral recreation testing procedure or combination thereof.

14. The method as defined in claim 10, wherein the ANP expert result and the model verification data are compared in a comparison unit.

15. The method as defined in claim 10, wherein the plurality of ANP expert questionnaires is provided to define a plurality of influent relation criteria to obtain a plurality of mutually influent relation values.

16. The method as defined in claim 15, wherein the plurality of mutually influent relation values is provided to build at least one direct-influence matrix which is further normalized to build at least one normalized influence matrix.

17. The method as defined in claim 16, wherein the at least one normalized influence matrix is calculated to obtain at least one total influence matrix which is further normalized to build at least one normalized total influence matrix.

18. The method as defined in claim 10, wherein limits of the at least one normalized total influence matrix are calculated to obtain at least one limited super matrix to thereby obtain a plurality of weights of criteria.
